(19) United States
(12) Patent Application Publication
(10) Pub. No.: US 2003/0227965 A1
(43) Pub. Date: Dec. 11, 2003

(54) Start-up state machine

(76) Inventors: Stewart J. Webb, San Diego, CA (US); Peter J. Sallaway, San Diego, CA (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/165,566

(22) Filed: Jun. 7, 2002

(51) Int. Cl. H04L 5/16

(52) U.S. Cl. 375/219

(57) ABSTRACT

State machines are disclosed for establishing a communication channel between communication devices, such as for example, between two modems in a backplane environment. In accordance with one embodiment, a start-up state machine employs the full data rate signaling scheme of the communication device to initiate a communication channel between two communication devices. By sending predefined bit patterns using the existing signaling scheme, the communication devices can determine the state of each other, establish a communication link, and determine when the communication of data or other desired information can occur.

### BACKGROUND

1. Field of the Invention

The present invention relates generally to communication devices and, more particularly, to systems and methods for the communication of information between communication devices.

2. Related Art

Communication systems are utilized to transmit and receive information between various locations. The information may travel between communication devices of varying distance, such as from one chip to another chip on a circuit board, between components within a cabinet or between cabinets, or between very distant communication devices. The channel through which the information flows from one communication device to another may comprise any medium, such as for example a copper wire, a coaxial cable, a waveguide, an optical fiber, or a radio frequency or other electromagnetic link.

A start-up procedure or a handshake procedure is often required, prior to the actual transmission of the desired information, to ensure that the communication devices are ready and able to transmit and receive data reliably and in a timely fashion. For example, if the communication devices are modems, each modem needs a certain time period to adapt their loops to the optimal values so that the reliable transfer of information can take place. This may be required following power up or when the communication link between the two modems has been lost. Furthermore, the modems may be powered on at different instances of time and may take different amounts of time to adapt their acquisition and tracking loops, because the start-up process for each modem is dependent upon many variables, including received data, noise and channel parameters as well as process, voltage and temperature variations or other imperfections.

Conventional communication systems often employ a low frequency channel to perform the start-up procedure for the communication devices. The start-up procedure utilizes a low-rate signaling scheme that differs from the higher-rate signaling scheme generally used for communicating the desired information (data) during normal operation. The low-rate frequency channel results in the need for additional software and/or hardware to support the additional signaling scheme and adds to the developmental complexity and associated hardware in the communication device. As a result, there is a need for improved start-up systems and methods for communication devices.

### BRIEF SUMMARY

Systems and methods for establishing a communication link between communication devices are disclosed. In accordance with one embodiment, a start up state machine is disclosed herein that functions to establish a communication link between communication devices. For example, the start-up state machine may utilize the existing signaling scheme of the communication device, for example in a master/slave arrangement, operating at the full data rate to initiate a communication channel and provide synchronization between the communication devices.

Specifically, in accordance with one embodiment of the present invention, a communication device includes a transmitter, a receiver, and a state machine coupled to the transmitter and to the receiver. The state machine controls the initiation of a communication link for the communication device by determining bit patterns for transmission by the transmitter at the full data rate based upon the status of the receiver and information contained in a signal transmitted by a remote communication device through a communication channel to the receiver.

In accordance with another embodiment of the present invention, a method of establishing a communication link between a local communication device and a remote communication device, includes transmitting at a full data rate a first predetermined bit pattern from the local communication device to the remote communication device if a receiver of the local communication device is not locked (where the device is considered locked if it is reliably decoding a pre-determined/known bit sequence) to an incoming signal; transmitting at a full data rate a second predetermined bit pattern from the local communication device to the remote communication device if the receiver of the local communication device is locked to an incoming signal; and establishing the communication link for transmission of desired information when the receiver of the local communication device is locked and is receiving the second bit pattern from the remote communication device.

In accordance with another embodiment of the present invention, a communication device includes a receiver adapted to receive an input signal, a transmitter to transmit an output signal, a detection circuit adapted to detect the receipt of the input signal, and a state machine, coupled to the receiver, the transmitter, and the detection circuit. The state machine is used to control start-up of the communication device to establish a communication link with a remote communication device. The state machine determines bit patterns to transmit at a full data rate based upon the status of the detection circuit, the receiver, and the input signal.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 shows an example of the inputs and outputs for a start-up state machine block in accordance with an embodiment of the present invention.

FIG. 2 shows a block diagram of a communication device incorporating a start-up state machine in accordance with an embodiment of the present invention.

FIG. 3 illustrates a flowchart for a start-up state machine in accordance with an embodiment of the present invention.

FIG. 4A shows another example of the inputs, outputs, and intermediary signals for an exemplary start-up state machine block in accordance with an embodiment of the present invention.

FIGS. 4B and 4C illustrates a state machine for start-up in accordance with an embodiment of the present invention.

FIG. 5 illustrates a detailed state-machine for a portion of the state-machine of FIG. 4B.

FIG. 6 illustrates a detailed state-machine for a portion of the state-machine of FIG. 4C

FIG. 7 illustrates a flowchart for a start-up state machine with master-slave arbitration in accordance with an embodiment of the present invention.

The preferred embodiments of the present invention and their advantages are best understood by referring to the detailed description that follows. It should be appreciated that like reference numerals are used to identify like elements illustrated in one or more of the figures.

### DETAILED DESCRIPTION

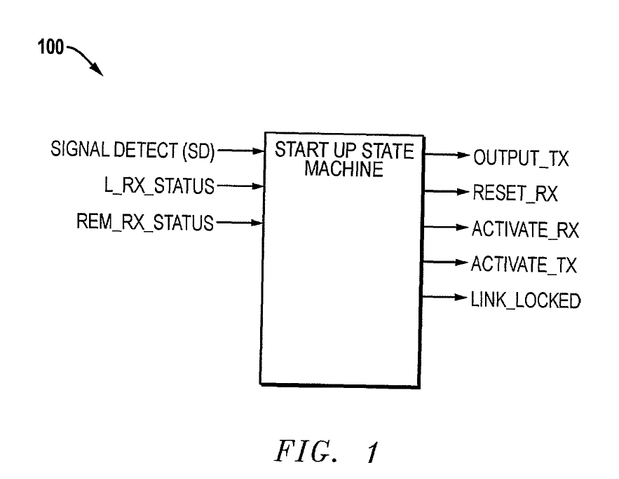

FIG. 1 shows a start-up state machine 100 in accordance with an embodiment of the present invention. Start-up state machine 100, in accordance with one or more embodiments described herein, is incorporated into a communication device to control the start-up or handshake procedure between communication devices within a communication system.

For example, if the communication devices are modems, each modem needs to be aware of the “state” of the other. The various modem “states” may include, for example, whether each modem is activated, has its receiver locked, is receiving or transmitting, and is receiving or transmitting a valid signal. Each modem must be aware of its own state and the state of the other modem to ensure the integrity of the connection. As an example, upon start up, a modem must determine if the designated remote modem is online and capable of receiving and transmitting valid signals. Typically, each modem requires an initial signal or sufficient preliminary data to adapt its loops and lock to incoming data. Once the start-up procedure is complete, the modems are able to communicate in a reliable fashion.

Start-up state machine 100 receives a number of input signals, including a signal detect (SD) signal, a L_RX_Status signal, and a REM_RX_Status signal. Start-up state machine 100 also provides a number of output signals, including an Output_TX signal, a Reset_RX signal, an Activate_RX signal, an Activate_TX signal, and a Link_Locked signal.

The signal detect (SD) signal indicates when there is a signal, having sufficient energy, being received by the local communication device through the communication channel. The L_RX_Status signal (also referred to herein as the local receiver status signal) indicates when the local descrambler (i.e., local receiver) is locked and decoding a signal. The REM_RX_Status signal (also referred to herein as the remote receiver status signal) is asserted when the local receiver is decoding a signal that indicates that the remote device is locked.

The Output_TX signal provides information to the local transmitter as to what type of information should be transmitted for a given state, such as data or control information. For example, a predetermined bit pattern “X” may be transmitted if the local receiver is not locked, while a predetermined bit pattern “Y” may be transmitted when the local receiver is locked. The bit pattern “X” and the bit pattern “Y” (also referred to herein as bad idles and good idles, respectively) notify the remote communication device that the receiver of the local communication device is either not locked or locked, respectively.

The Reset_RX signal resets the local receiver. For example, if the communication device is a modem, the Reset_RX signal resets the receiver so that all of the loops start in a known “good” condition. This signal resets the loops and prevents them from tracking or wandering off to invalid values due to the lack of data or improper data on the medium. The Activate_RX signal activates the local receiver, such as for example, when valid data is determined to be on the channel due to the assertion of the signal detect (SD) signal.

The Activate_TX signal indicates whether to switch on or off the transmitter. For example, this signal can be used to notify the remote communication device that the local communication device has a problem, such as a loss of receiver lock, by temporarily turning off the transmitter. Thus, both communication devices can then begin the restart procedure in a known “good” state. The Link_Locked signal indicates that the local and remote communication devices are locked and ready to transmit and receive data.

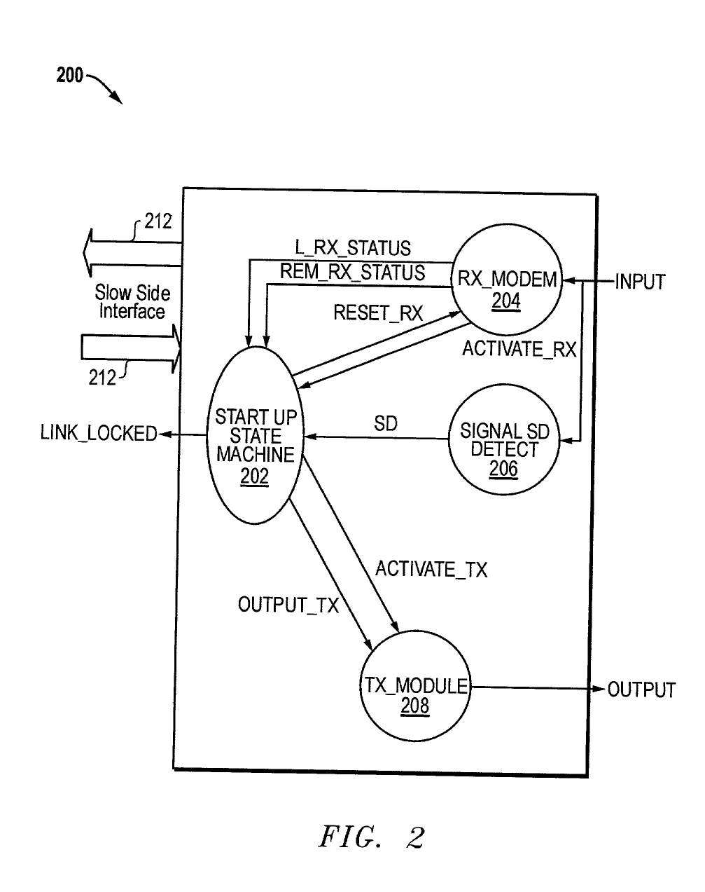

Start-up state machine 100, as noted above, can be incorporated into a communication device to control the start-up or handshake procedure between communication devices within a communication system. For example, FIG. 2 shows a block diagram of a communication device 200 incorporating a start-up state machine 202 in accordance with an embodiment of the present invention. Start-up state machine 202 is an exemplary embodiment of start-up state machine 100 incorporated into communication device 200.

Communication device 200, which for example may represent a modem or other type of communication device, includes start-up state machine 202, a receiver module (RX_MODEM) 204, a signal detect (SD) module 206, and a transmitter module (TX_MODULE) 208. Communication device 200 is coupled to a communication channel to receive an input signal and provide an output signal. Communication device 200 also provides the Link_Locked signal and a data interface 212 to associated circuitry (not shown) that is coupled to or part of communication device 200.

Communication device 200 is shown in a block diagram form, but it should be understood that the various blocks or modules may be incorporated and instantiated as software or hardware, or some combination of the two. As an example, communication device 200 may form a single chip (e.g., an application specific integrated circuit) or multiple chips. Start-up state machine 202 forms part of this circuitry on one or more chips or, alternatively, forms part of the software code executed by a processor and associated hardware to monitor various signals and control various modules, as discussed herein.

Start-up state machine 202 receives as input signals the L_RX_Status signal, the REM_RX_Status signal, and the signal detect (SD) signal and provides as output signals the Reset_RX signal, the Activate_RX signal, the Activate_TX signal, the Output_TX signal, and the Link_Locked signal. These signals, as discussed above in reference to FIG. 1, are used by start-up state machine 202 to control or communicate with receiver module 204 and transmitter module 208, for example, during start-up or communication initiation of communication device 200 with another communication device.

Signal detect (SD) module 206 is coupled to an input terminal to receive the input signal. Signal detect (SD) module 206 asserts the signal detect (SD) signal and provides this signal to start-up state machine 202 when a signal having sufficient energy is detected at the input to the receiver (i.e., receiver module 204).

Start-up state machine 202 provides the Reset_RX and Activate_RX signals to receiver module 204. The Reset_RX signal is used to reset the receiver circuitry to a known “good” condition from which the device will attempt to adapt to the optimum values. The Activate_RX signal is used to control when this adaptation takes place. Similarly, start-up state machine 202 provides the Activate_TX and Output_TX signals to transmitter module 208. The Activate_TX signal is used to control when the transmission circuitry operates, for example, forcing the transmitter to not transmit when the Activate_TX signal is de-asserted. The Output_TX signal is used to tell the transmitter what type of information to transmit, for example, control information or data.

Start-up state machine 202 receives the L_RX_Status signal and the REM_RX_Status signal from receiver module 204. The L_RX_Status signal is asserted when the local receiver is locked and remains asserted until it is determined that the device is no longer decoding data reliably. This may be achieved in a variety of ways, for example, by looking at the average error at the slicer, or in systems that employ forward error correction, excessive normalization in the decoder could be used to indicate that the device is no longer decoding reliably. The REM_RX_Status signal is used to show that the remote receiver has flagged or indicated that it is locked, which may be discerned by the content of the data decoded locally (i.e., the data transmitted by the remote receiver, for example, patterns “X” or “Y” as discussed herein).

As an example of signal states for a typical start-up of communication device 200, start-up state machine 202 asserts the Activate_TX signal and commands transmitter module 208 to start transmitting with the bit pattern “X” by using the Output_TX signal. When a signal is detected at the input terminal, the signal detect (SD) signal is asserted. Receiver module 204 is then activated by assertion of the Activate_RX signal and transmitter module 208 continues to transmit the bit pattern “X”. When receiver module 204 is locked to the incoming signal, receiver module 204 asserts the L_RX_Status signal, which is received by start-up state machine 202. Start-up state machine 202 commands transmitter module 208, using the Output_TX signal, to start transmitting the bit pattern “Y” to indicate to the remote communication device that the receiver of communication device 200 is locked.

When receiver module 204 determines that the remote receiver is locked (based upon the incoming bit pattern “Y” on the incoming signal), receiver module 204 asserts the REM_RX_Status signal. If the REM_RX_Status signal and the L_RX_Status signal are both asserted, then start up state-machine 202 asserts the Link_Locked signal. The asserted Link_Locked signal indicates that the communication devices (i.e., communication device 200 and the remote communication device that is not shown) are locked and ready to transmit and receive data.

By using predetermined bit patterns (e.g., the bit pattern “X” and the bit pattern “Y”), communication device 200 communicates its state to a remote communication device. As in the example above, the transmitted bit pattern “X” indicates to the remote communication device that receiver module 204 is not locked to the remote communication device's signal. The transmitted bit pattern “Y” indicates to the remote communication device that receiver module 204 is locked to the remote communication device's signal. Likewise, receiving the bit pattern “Y” or the bit pattern “X” (i.e., after being decoded) by receiver module 204 indicates to communication device 200 whether the remote communication device has its receiver locked or not locked, respectively, and thus, whether it is ready to communicate data or the desired information back and forth.

The bit pattern “X” and the bit pattern “Y” may comprise any predetermined bit sequence, such as for example zeros and ones, respectively, which can then be scrambled, encoded and transmitted. The receiving (remote) communication device can then lock all of its loops to the known scrambled bit pattern (i.e., bad idles or good idles). Since this is a duplex system, the remote communication device is likewise transmitting a predetermined bit pattern (i.e., bad idles or good idles) to the local communication device. The transmitted bit pattern can be changed from the bit pattern “X” (i.e., bad idles) to the bit pattern “Y” (i.e., good idles) once the receiver locks to the incoming signal.

Consequently, in the duplex system, both communication devices are transmitting and receiving and attempting to lock their respective local receivers simultaneously. Each communication device having a start-up state machine monitors its state and the state of the remote device to determine when the communication link between them is established and locked. Once this is achieved, both communication devices are ready to transmit and receive data.

This start-up method and signaling scheme uses the existing coder/decoder to encode/decode a predetermined bit pattern that facilitates timing and synchronization between the two communication devices. Consequently, the start-up signaling scheme operates at the full data rate with no wasted symbols in the transmitter, providing an efficient utilization of the symbol set. Due to the fact that none of the transmit symbols are used solely for start-up signals, all of the symbols are available to encode data. Furthermore, a separate signaling scheme is not required for start-up, eliminating the need for the associated development and complexity of additional hardware in the transceiver. For example, there is no need for a dedicated channel or back channel utilizing a low data rate signaling scheme as in some conventional communication devices. In contrast, in accordance with an embodiment of the present invention, the signaling scheme requires only a small amount of hardware overhead in the transceiver or modem connections to perform the start up.

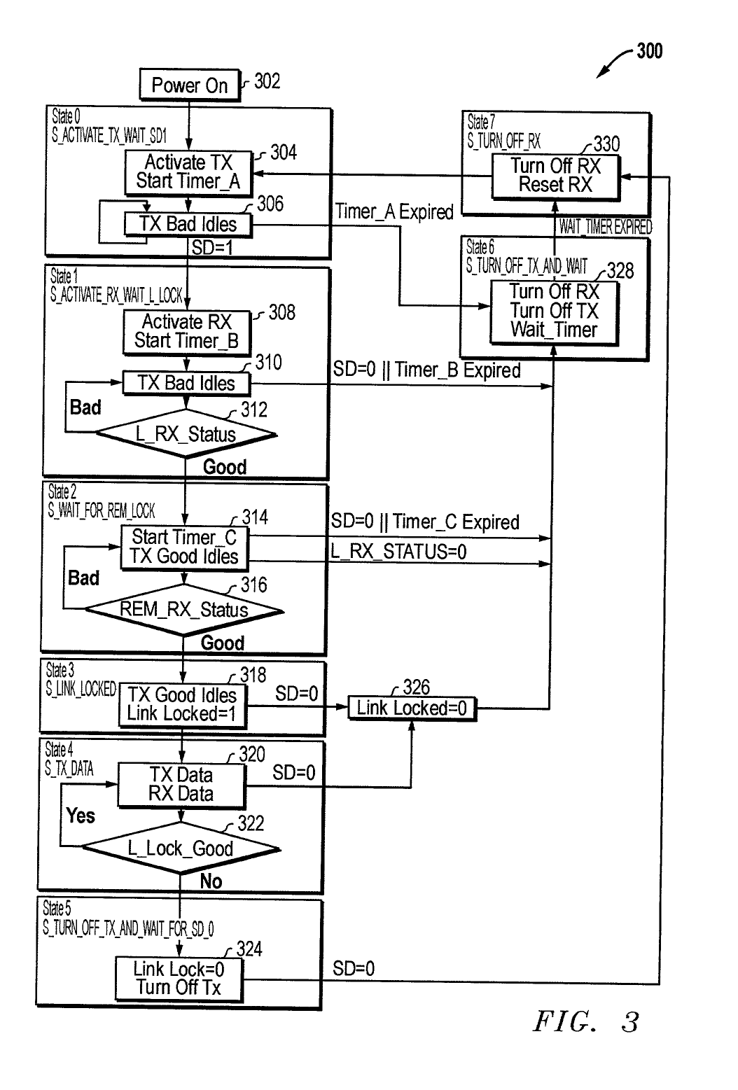

FIG. 3 illustrates a flowchart 300 for a start-up state machine in accordance with an embodiment of the present invention. Flowchart 300 provides an exemplary start-up procedure implemented by an embodiment of the start-up state machine, such as described in reference to FIG. 1 or 2, for a communication device. Upon power up the start-up state machine enters a state zero. The transmitter is activated and a Timer_A is started (step 304), with the transmitter transmitting the bit pattern “X” (i.e., bad idles) that indicates to the remote communication device that the receiver of the local communication device is not locked (step 306). Steps 304 and 306 form a zero state (state 0—labeled S_Activate_TX_Wait_SDI in FIG. 3).

The Timer_A prevents deadlock from occurring, such as for example, when the remote communication device is waiting for the signal detect (SD) signal to go low and the local communication device is waiting for the signal detect (SD) signal to go high. Thus, if the period set for the Timer_A expires, the transmitter is shut off and the state machine enters state 6, discussed below.

If the signal detect (SD) signal is asserted, the receiver is activated and a Timer_B is started (step 308). The transmitter continues to transmit the bit pattern “X” (step 310) until the local receiver achieves lock (step 312—lock is indicated by the L_RX_Status signal being asserted) or the time period set for the Timer_B expires or the signal detect (SD) signal is de-asserted. If the Timer_B period expires or the signal detect (SD) signal is de-asserted, then the state machine enters state 6. Steps 308, 310, and 312 form a first state (state 1—labeled S_Activate_RX_Wait_L_Lock).

The Timer_B provides a safe recovery route if, for example, the remote communication device has advanced for some faulty reason and is transmitting data (rather than good or bad idles) prior to both communication devices being locked and the communication channel established. Consequently, under this exemplary condition, the local receiver would never achieve scrambler or “bit” lock (i.e., the L_RX_Status signal would not be asserted) and would continue to transmit the bit pattern “X” (i.e., bad idles).

If the local receiver is locked, the transmitter transmits good idles (i.e., the bit pattern “Y”) and a Timer_C is started (step 314). The REM_RX_Status signal is monitored (step 316) to determine when the remote receiver is locked. If signal detect (SD) signal is de-asserted or the L_RX_Status signal is de-asserted or the Timer_C time period expires, the state machine enters state 6. Steps 314 and 316 form a second state (state 2—labeled S_Wait_For_REM_Lock).

The Timer_C time period provides a recovery route if, for example, the remote communication device never transmits good idles. Under this condition, the remote communication device may be transmitting data (i.e., advanced beyond start-up), which would force the signal detect (SD) signal and possibly the L_RX_Status signal of the local communication device to be asserted. However, the REM_RX_Status signal would not be asserted (unless the transmitted data happens to match the bit pattern “Y”). Thus, the state machine may recover from this faulty state, but the Timer_C sets a time limit for recovery to occur.

If the REM_RX_Status signal is asserted, due to receiving good idles (i.e., the bit pattern “Y”) then at step 318 the transmitter continues to transmit good idles and the Link_Locked signal is asserted. Step 318 forms a third state (state 3—labeled S_Link_Locked). If the signal is lost as indicated by the signal detect (SD) signal being de-asserted then the Link_Locked signal is de-asserted and the state machine enters state 6.

Once the Link_Locked signal is asserted, start-up is complete and the communication link between the local and remote communication device is established. The desired information or data can then be transmitted and received between the communication devices (step 320). If the signal detect (SD) signal is de-asserted, indicating that a signal is no longer present at the input to the local receiver, then the Link_Locked signal is de-asserted and the state machine enters state 6 (step 328). Step 322 in FIG. 3 monitors the local receiver to ensure that the communication channel has not lost lock. Step 322 may monitor a L_Lock_Good signal, which could consist of, for example, a combination of many other indicators. The L_Lock_Good signal could include but is not limited to, for example, an mse_ok signal (indicating the severity of errors at the slicer), a norm_ok signal (that might indicate how often normalization was taking place in a forward error correction mechanism (FEC)), as well as any other suitable indicators. Steps 320 and 322 form a fourth state (state 4—labeled S_TX_Data).

If a good lock is not maintained (as indicated by the L_Lock_Good signal at step 322), the Link_Locked signal is de-asserted and the transmitter is turned off (step 324) until the signal detect (SD) signal is de-asserted (i.e. the far end (remote receiver) has stopped transmitting). The state machine then transitions from state five (state 5—labeled S_TURN_OFF_TX_AND_WAIT_FOR_SD_{—}0) to state seven.

If the state machine transitions to state 6, for example, based upon one of the conditions noted above, the receiver and transmitter are turned off and a Wait_Timer is started (step 328, which forms state 6—labeled S_TURN_OFF_TX_AND_WAIT). The Wait_Timer ensures that the remote receiver is also forced to restart the process. Because the local receiver's transmitter is no longer transmitting, the remote receiver will no longer register a signal on the medium and consequently de-assert the signal detect (SD) signal. Should the remote receiver be in any of the states 1 through 5, the loss of the signal detect signal will ensure a return to state 0 either via state 7 or via both states 6 and 7.

After the Wait_Timer expires, the state machine then transitions to state 7 (step 330). Upon transition to state 7, the receiver is turned off (e.g., if state 6 was bypassed) and reset (step 330) and the state machine transitions to state 0, described above, with the process repeating. Step 330 forms a seventh state (state 7—labeled S_TURN_OFF_RX).

Flowchart 300 provides an exemplary flowchart of various states for a state machine, such as described in reference to FIGS. 1 and 2. For example in reference to FIG. 2, flowchart 300 covers the various states of start-up state machine 202 to control start-up for communication device 200.

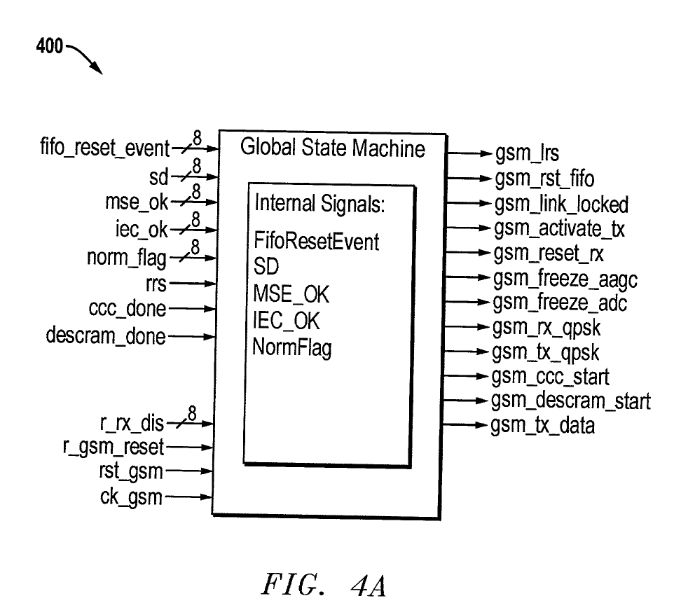

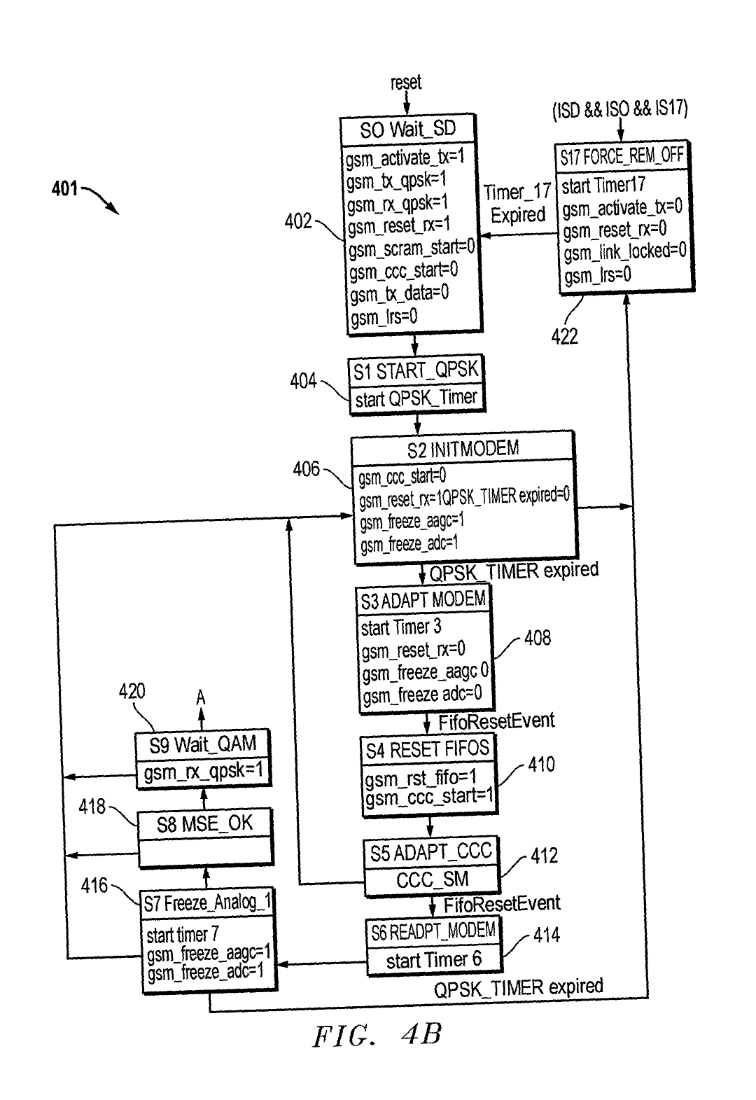

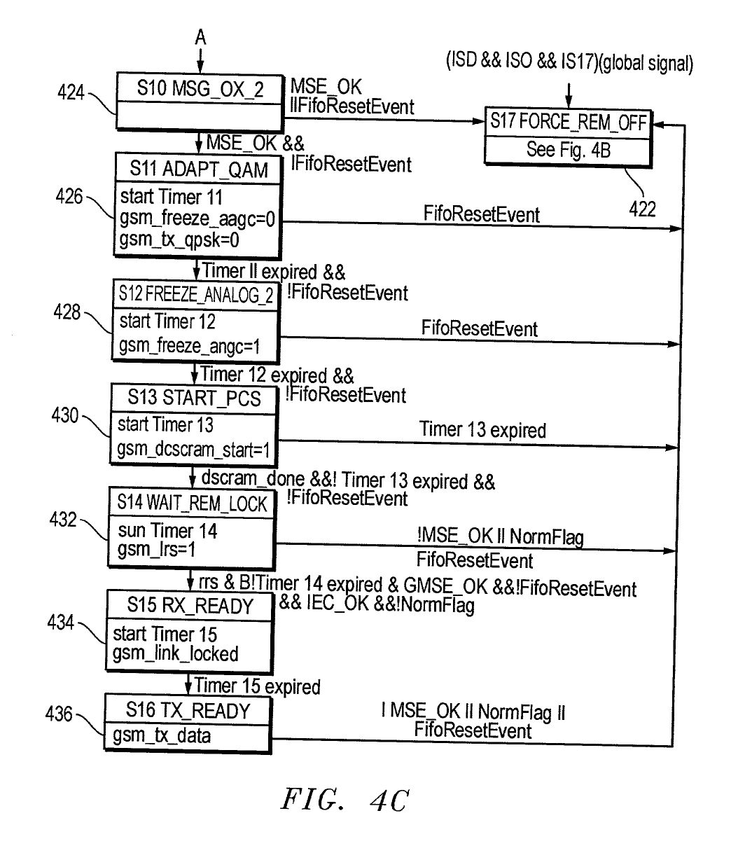

FIG. 4A shows a block diagram providing a more detailed example of a state machine implementation, in accordance with an embodiment of the present invention, designed to facilitate reliable start up of devices communicating with each other over any given medium. The exemplary block diagram is labeled Global State Machine (or gsm).

The system described here will work using p channels where “p” is a number greater than zero. It may be that some embodiments require flexibility in the number of channels being used and may require the implementation of a variety of methods to control which channels are in use. The exemplary embodiment described in reference to FIG. 4A uses up to eight channels, where the channels that are actually in use are selected by a r_rx_dis signal, as described in further detail below. It may also be that other embodiments may choose to have a fixed number of channels p. In this case the r_rx_dis signal or the equivalent method for controlling which channels are in use would be redundant.

The input signals provided to a global state machine 400 (FIG. 4A) are as follows; fifo_reset_event[7:0], sd[7:0], mse_ok[7:0], iec_ok[7:0], norm_flag[7:0], rrs, ccc_done, descram_done, r_rx_dis[7:0], r_gsm_reset, rst_gsm, and ck_gsm. Various other input signals or registered inputs may also be provided, for example, for test purposes.

The r_rx_dis[7:0] signal is an 8 bit control signal used to indicate which channels are being used for receiving data (i.e., a bit not asserted indicates the corresponding channel is being used). All of the following 8-bit input signals are qualified with this signal, as specifically described below, in order to determine their significance. For example, if the resulting 1-bit signal requires that all the bits be logically ANDed together, meaning all of the bits of interest have to be set to give a logical “1”, then the r_rx_dis signal would be used as follows: one_bit_result=AND of the bits resulting from (8_bit_input|r_rx_dis), where “|” represents bitwise OR. This means that any bit not set on a channel of interest would remain not set and any bits of disabled channels would be forced to a logical “1”. Hence only bits on channels of interest could cause the 1-bit result to be a logical “0”.

Similarly if the resulting 1-bit signal requires all of the bits to be logically ORed together, meaning that it takes a logical “1” if any bit is set, then the r_rx_dis signal would be used as follows: one_bit_result=OR of the bits resulting from (8_bit_input & ˜r_rx_dis), where “˜” means bitwise invert and “&” means bitwise AND. This means that signals on the channels that are disabled are forced to zero and cannot cause the result to be a logical “1”.

Note that in the description herein and the figures, “|” means bitwise OR, “∥” means logical OR, “\hat{ }” means exclusive OR, “&” means bitwise AND, “&&” means logical AND, “˜” means bitwise invert, and “!” means logical invert for the associated signals of interest.

The fifo_reset_event[7:0] signal is an 8-bit signal, 1 bit coming from each of the 8 channel's ADC FIFOs, indicating when they have been reset. The FIFOs may be reset if an overflow event occurs, hence the data out can no longer be deemed reliable, or at the request of the global state machine.

The signal detect (sd[7:0]) signal is an 8 bit signal, 1 bit for each channel, and is used to indicate when the energy on each channel is sufficient such that a signal is deemed to be present.

The mse_ok[7:0] (mean squared error ok) signal is an 8-bit signal, 1 bit from each channel, and is used to indicate that we are able to receive data reliably. An example of a method to do this is to monitor the errors at the receive slicer to check that they are within an acceptable range.

The iec_ok[7:0] (idle error counter ok) signal is an 8-bit signal, 1 bit from each channel, which is used to indicate if a channel is making too many errors while receiving idle signals.

The norm_flag[7:0] (normalization flag) is an 8-bit signal, 1 bit from each channel, indicating if excessive normalization events are taking place in each channel's forward error correction (FEC) circuitry.

The rrs (remote receiver status signal) is a 1-bit signal used to indicate to the local receiver that the remote receiver has successfully achieved PCS (Physical Coding Sublayer) lock. This is indicated in the local receiver by decoding good idles (i.e., the bit pattern “Y”). PCS lock is considered to be achieved when the modem is successfully decoding idles.

The ccc_done signal is a 1-bit control signal used to indicate that the CCC (Cross Channel Cancellation) state-machine has completed successfully. The CCC state-machine is used to choose the optimum taps for canceling estimated inter-channel interference.

The descram_done signal is a 1-bit signal used to indicate that the local receiver is successfully decoding idle signals. This signal is used to indicate the PCS (Physical Coding Sublayer) state-machine has completed successfully.

The rst_gsm signal is a control signal used to force the state machine to a known state, typically when the device is first powered on.

The global state-machine also shows a number of internal signals that are used in FIGS. 4B and 4C. These 1-bit signals are as follows; SD, MSE_OK, IEC_OK, NormFlag, and FifoResetEvent.

The signal SD is a 1-bit signal derived from the 8-bit input signal sd[7:0]. The SD signal is the logical AND of the bits of sd[7:0] qualified with r_rx_dis[7:0]. Thus, the SD signal is a logical 1 when all of the bits of interest, as dictated by r_rx_dis[7:0], are simultaneously a logical 1, else the SD signal is a logical 0.

The signal MSE_OK is a 1-bit signal derived from the 8-bit input signal mse_ok[7:0]. The MSE_OK signal is the logical AND of the bits of mse_ok[7:0] qualified with r_rx_dis[7:0]. Thus, the MSE_OK signal is a logical 1 when all of the bits of interest, as dictated by r_rx_dis[7:0], are simultaneously a logical 1, else the MSE_OK signal is a logical 0.

The signal IEC_OK is a 1-bit signal derived from the 8-bit input signal iec_ok[7:0]. The IEC_OK signal is the logical AND of the bits of iec_ok[7:0] qualified with r_rx_dis[7:0]. Thus, the IEC_OK signal is a logical 1 when all of the bits of interest, as dictated by r_rx_dis[7:0], are simultaneously a logical 1, else the IEC_OK signal is a logical 0.

The signal NormFlag is a 1-bit signal derived from the 8-bit input signal norm_flag[7:0]. The NormFlag signal is the logical OR of the bits of norm_flag[7:0] qualified with r_rx_dis[7:0]. Thus, the NormFlag signal is a logical 1 when any of the bits of interest, as dictated by r_rx_dis[7:0], are a logical 1, else the NormFlag signal is a logical 0.

The signal FifoResetEvent is a 1-bit signal derived from the 8-bit input signal fifo_reset_event[7:0]. The FifoResetEvent signal is the logical OR of the bits of fifo_reset_event[7:0] qualified with r_rx_dis[7:0]. Thus, the FifoResetEvent signal is a logical 1 when any of the bits of interest, as dictated by r_rx_dis[7:0], are a logical 1, else the FifoResetEvent signal is a logical 0.

This embodiment (i.e., global state machine 400) of a start up state-machine also has various outputs including, gsm_lrs, gsm_rst_fifo, gsm_link_locked, gsm_activate_tx, gsm_reset_rx, gsm_freeze_aagc, gsm_freeze_adc, gsm_rx_qpsk, gsm_tx_qpsk, gsm_ccc_start, gsm_descram_start, and gsm_tx_data. Note that the prefix gsm is used to indicate that the signals originate from the global state machine.

The gsm_lrs (local receive status) signal is used to determine which bit pattern to transmit, while transmitting idles. This indicates to the remote receiver whether or not the local device has achieved PCS lock or not (i.e. whether or not it is successfully decoding idles).

The gsm_rst_fifo (reset ADC FIFOs) signal is used to force the ADC FIFOs to reset.

The gsm_link_locked signal is used to declare to the outside world that the link between the two devices has been successfully achieved. This signal is used such that, upon assertion, the local device should be ready to receive data, but should only start transmitting data some time delay later. The minimum time delay is ultimately determined by a Timer15 described in reference to FIG. 4C.

The gsm_activate_tx signal is used to control the transmit data path, forcing the output of the device to be silent if the gsm_activate_tx signal is de-asserted.

The gsm_reset_rx signal is used to reset the receive data path to a known “good” condition, in order to provide it with the best possible chance of locking to incoming data over the widest possible range of scenarios. The signal detect circuitry should not be affected by this signal.

The gsm_freeze_aagc (freeze analog automatic gain control) signal is used to control when the analog gain control circuitry is allowed to adapt.

The gsm_freeze_adc (freeze analog direct current offset) signal is used to control when the analog DC offset circuitry is allowed to adapt.

The gsm_rx_qpsk (receive quaternary phase Shift keying) signal is used to control whether the slicer is set up to slice quaternary phase shift keying (QPSK) or quadrature amplitude modulation (QAM) signals.

The gsm_tx_qpsk (transmit quaternary phase Shift keying) signal is used to control whether the transmitter is set up to transmit quaternary phase shift keying (QPSK) or quadrature amplitude modulation (QAM) signals.

The gsm_ccc_start (cross channel cancellation) signal is used to control when the cross channel cancellation state machine begins to determine the optimum CCC tap positions.

The gsm_descram_start (descrambler start) signal is used to control when the PCS (Physical Coding Sublayer) state machine executes. The PCS state machine is used to provide synchronization of the receive modem's descrambler with the transmit modem's scrambler. The PCS state machine is also used to account for delay skew among the channels and to determine successful decoding of incoming idle signals.

The gsm_tx_data signal is a 1-bit signal used in the transmitter to control whether to transmit control information or data.

FIGS. 4B and 4C illustrate a more detailed state machine 401 for a start-up state machine in accordance with an embodiment of the present invention. For example, state machine 401 may represent a more detailed embodiment of global state machine 400, described in reference to FIG. 4A. State-machine 401 provides an exemplary start-up state machine for a communication device, such as for example, a modem. As an example, state machine 401 is applicable for single or multi-channel communication devices communicating through a backplane.

Additional details for an exemplary communication system operating in a backplane environment, which one or more embodiments of the present invention would have applicability, can be found in U.S. application Ser. No. 10/071,771, filed Feb. 6, 2002, entitled “High-Speed Multi-Channel Communications Transceiver with Inter-Channel Interference Filter,” which is incorporated herein by reference in its entirety.

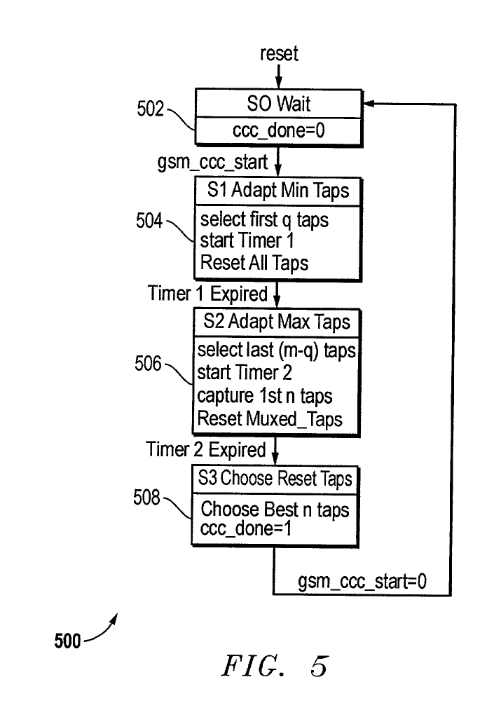

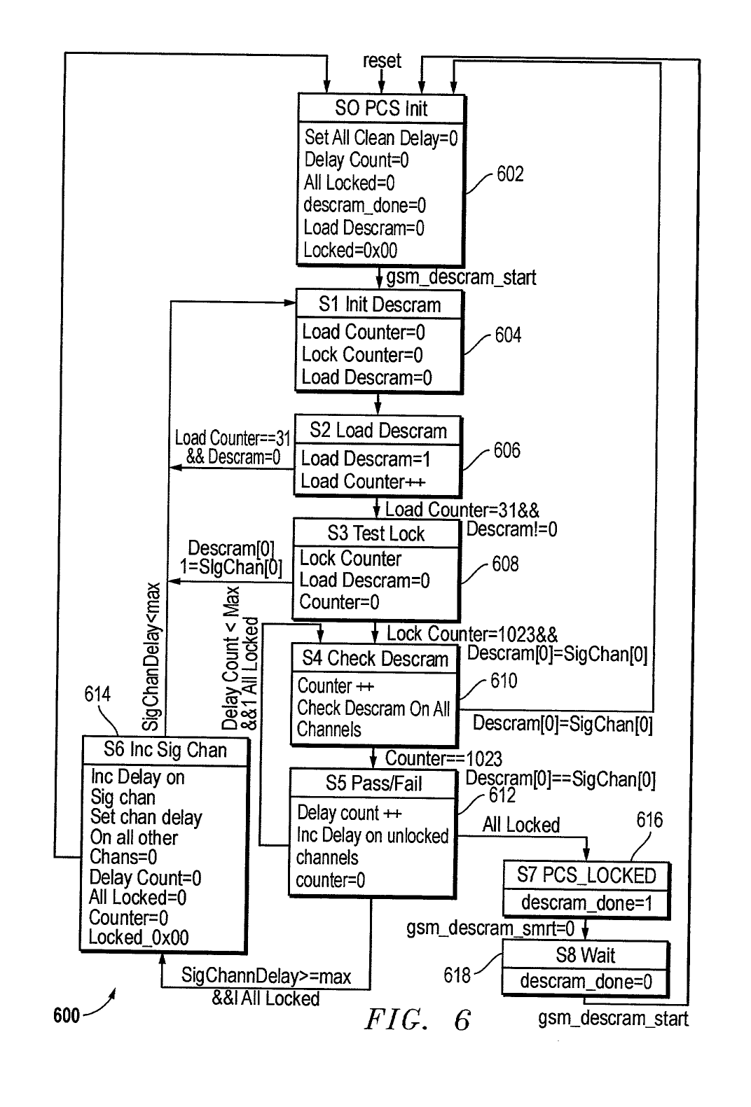

State machine 401 (also referred to herein as the global state machine) controls the start-up process and provides details as to the general control of start-up and modem acquisition for the communication device. State machine 401 can also utilize other state-machines, illustrated in FIGS. 5 and 6 and corresponding to state machines 500 and 600. State machine 500 provides details of a state machine (labeled CCC_SM or cross-channel cancellation state machine) that can be used during modem acquisition to determine the optimum cancellor taps based on the estimated signal interference for each channel in systems that have multiple channels interfering with each other. State machine 600 provides details of a state machine (labeled PCS_SM or physical coding sublayer state machine) that synchronizes the descrambler with the far end (remote) scrambler, provides delay skew compensation, and determines when the modem is “bit” locked in systems that implement a PCS layer.

For state machine 401, after reset, the state machine enters a state zero (step 402 and labeled S0 Wait_SD), where certain signals are set, the transmitter is activated, and the signal detect (SD) signal is monitored. The gsm_tx_qpsk signal is used to command the transmitter section to start sending quadrature amplitude modulation (QAM) signals. The QAM signals begin when the quaternary phase shift keying (QPSK) timer has expired (if a successful QPSK lock has occurred).

QPSK signals are transmitted initially in order to improve the probability that the modem will acquire satisfactorily. The signaling scheme is switched to QAM in order to increase the bits per symbol and hence data throughput. The gsm_rx_qpsk signal can be set to 0 (de-asserted) after successful adaptation to the incoming QPSK signal as determined by the MSE_OK signal being asserted (e.g., transitioned to a high logic level). The gsm_rx_qpsk signal can be set to 0 (de-asserted) once the receiver is locked to the QPSK signal. This can occur well before the expected receipt of QAM signals. The slicer is then ready to receive QAM signals. The two modems (i.e., local and remote modem) can become synchronized via the QPSK timer.

The gsm_activate_tx signal is asserted so that the local device will begin to transmit. When the gsm_tx_data signal is de-asserted, the device (i.e., the communication device controlled by global state machine 401) will transmit start up information, for example, the pattern “X”. When the gsm_tx_data signal is asserted, the device will transmit data from external sources, for example, via data interface 212 (shown abstractly in FIG. 2). Data interface 212 may be any suitable interface, for example, the SFI-4 (OC-192 Serdes-Framer interface).

While in state 0, the gsm_reset_rx signal is asserted in order to hold the receive circuitry at “safe” values. This is done because signal detect circuitry has not indicated via the SD signal that there is any activity on the medium (i.e., communication channel).

The gsm_ccc_start and gsm_scram_start signals are set to 0 so that the CCC state machine and PCS state machine, respectively, may be synchronized and started at the appropriate time, in subsequent state machine states. This prevents them from running continuously. Also the gsm_lrs signal is de-asserted, indicating that the local receiver is not locked.

Upon assertion of the signal detect (SD) signal, state machine 401 transitions to state 1 and a QPSK Timer (labeled QPSK_TIMER) is started (step 404). The QPSK Timer is used to synchronize the transition from QPSK to QAM signaling, to ensure that both communication devices are ready to receive QAM signals well before any are transmitted. Consequently, the QPSK Timer's scope is beyond that of a single state. The switch from QPSK to QAM takes place when the QPSK Timer expires. The delta time difference from one modem switching from transmitting QPSK data to transmitting QAM data and the other modem, that forms the communication link, also switching to QAM mode, is at most the time it takes to trigger the signal detect (SD) signal (e.g. in some cases a few thousand clock cycles).

Table 1, shown below, provides exemplary timer values for various timers referenced in the figures. For example, the GSM Timer values and QPSK Timer values correspond to the timers referenced in FIGS. 4B and 4C, while the CCC Timer values correspond to the timers referenced in FIG. 5.

TABLE 1
Exemplary Timer Values

| GSM TIMER | TIME (MILLISECONDS) |
|---|---|
| 3 | 5 |
| 6 | 10 |
| 7 | 5 |
| 11 | 5 |
| 12 | 1 |
| 13 | 0.5 |
| 14 | 5 |
| 15 | 0.5 |
| 17 | 0.2 |
| QPSK_TIMER | 60 |
| CCC TIMER | TIME (MILLISECONDS) |
| 1 | 4 |
| 2 | 4 |

The state machine transitions from state 1 to state 2 (step 406), which is an initialization state that allows the modem to be reinitialized without affecting the QPSK_TIMER. This allows for multiple attempts to lock the receiver. In state 2 the gsm_ccc_start signal is set to 0, allowing the CCC state machine to initialize and reset the CCC taps so that they are ready for operation in state 5. De-assertion of the gsm_ccc_start signal is required in this state to accommodate failed attempts to lock. The gsm_reset_rx signal is asserted which resets the receiver's loops so that they are ready for adaptation in state 3 (step 408). The gsm_freeze_aagc and gsm_freeze_adc signals are also asserted, freezing the analog AGC and analog DC offset circuitry until they are required to be adapted.

While in state 2, if the QPSK_Timer has expired, indicating that the local receiver has not successfully adapted to the QPSK data in time, the state machine enters state 17 (step 422). State 17 provides a safe initialization route and forces the link partner to reset, if the local input signals indicate the link has not been successful at various stages throughout the state machine. State 17 resets the receiver circuitry and de-asserts the gsm_link_locked signal to ensure that any monitoring circuitry is aware that the link has been lost. The de-assertion of the gsm_activate_tx signal forces the transmit circuitry to be silent for the period of Timer17. Switching off the transmit circuitry will cause the far end device to drop signal detect, initializing a similar reset sequence in the link partner. The state machine transitions to State zero upon completion of Timer17.

Otherwise, if the QPSK_TIMER has not expired, the state machine transitions from state 2 to state 3 (step 408), where the gsm_reset_rx signal and both the gsm_freeze_aagc and the gsm_freeze_adc signals are all set to zero. Also Timer3 is started. Step 408 starts the modem's adaptation of its loops from a known position. The Timer3 is sufficient in duration to ensure that a frequency lock can be achieved, which in turn stabilizes the ADC FIFOs (first in first out) and allows more accurate estimation of the CCC taps. Frequency lock is required in systems that recover the local frequency from a remote signal. This might also be used to simplify, as in this case, the requirements for the cancellation of cross channel interference, or to provide more robust echo cancellation.

When the Timer3 expires, the state machine enters state 4 (step 410), where the gsm_rst_fifo signal can be set to 1. Note that this signal can be implemented as a pulse, that is it goes high briefly and then back low. This is to ensure that the gsm_rst_fifo signal does not cause the FifoResetEvent signal to trigger in state 5. In systems where FIFOs between the ADCs and the digital receiver are implemented, the gsm_rst_fifo signal is used to reset the analog-to-digital converter FIFOs or ADC FIFOs. The FIFO registers are reset to help minimize the number of taps that are required in order to get optimal performance from the cross channel cancellation circuitry, which may be used in systems with multiple channels that interfere with each other. A gsm_ccc_start signal can also be set to one. The gsm_ccc_start signal enables the CCC state machine.

The global state machine enters state 5 and waits for the CCC state machine to complete. An example of a CCC state machine is described in reference to FIG. 5 for state machine 500. Completion of the CCC state machine is indicated by the ccc_done signal being asserted. The CCC state machine chooses the best subset of tap positions from a possible range of tap positions in order to help optimize a given hardware architecture. This may be implemented using a set of k taps (where k≧0), that are fixed in position and then choosing the best n taps from a set of m taps, where (0≦n≦m).

Referring briefly to FIG. 5, in state 0 (step 502) a ccc_done signal is set to zero. The ccc_done signal indicates when the optimum CCC taps have been determined. Upon assertion of a gsm_ccc_start signal the CCC state machine transitions from state 0 to state 1 (step 504). A Timer1 is started and all taps are reset. The first q non-fixed taps are allowed to adapt. While the CCC state machine is running, the fixed taps are also being adapted.

When Timer1 expires, the state machine transitions to state 2 (step 506). In step 506, a Timer2 is started, the values of the first q non-fixed taps are captured and the next set of (m−q) non-fixed taps are initialized and allowed to adapt. When the Timer2 expires, step 508 (state 3) selects the best n taps and asserts the ccc_done signal. The best n taps could be chosen based on their relative size, i.e., choose the most significant taps, and in some systems it may also be prudent to enforce the choice of consecutive taps. Although two adaptation periods are shown, one skilled in the art can readily extend this to further periods in order to accommodate any hardware/system requirements. The CCC state machine will remain in state 3 until gsm_ccc_start signal is de-asserted.

Returning to FIG. 4B, if a fifo_reset_event occurs at any time while the global state machine is in state 5, the global state machine will transition to state 2 (step 406) regardless of the state of the CCC state machine. The global state machine enters state 6 (step 414) if the ccc_done signal is asserted and a fifo_reset_event has not occurred. Step 414 starts a Timer6, which is of sufficient duration to enable the modem to adapt to near optimum values with the chosen CCC tap settings. When the Timer6 expires and the fifo_reset_event has not been set while in state 6, the state machine enters state 7 (step 416).

State 7 starts a Timer 7 and asserts the gsm_freeze_aagc and gsm_freeze_adc signals. While in state 7, if the QPSK_Timer has expired, the state machine enters state 17 (step 422). If the QPSK_Timer does not expire and the fifo_reset_event signal is asserted while in state 7, then the state machine enters state 2.

If the state machine is in state 7 when the Timer7 expires and if the QPSK_Timer has not expired and the fifo_reset_event signal was not asserted, then the state machine enters state 8 (step 418). If the MSE_OK signal is not asserted or the fifo_reset_event signal is asserted, the state machine returns to state 2. If the MSE_OK signal is asserted, indicating that the error on each channel at the slicer is acceptable and the fifo_reset_event signal is not asserted, the state machine enters state 9 (step 420), where the gsm_rx_qpsk signal is set to zero. This prepares the receiver's slicer to receive QAM data.

In states 5 through 9, the state machine returns to state 2 if a fifo_reset_event signal is asserted at any time. The fifo_reset_event signal indicates that the ADC FIFOs have overflowed. Once a fifo_reset_event has occurred the CCC tap choices are unlikely to be optimal, therefore they need to be readapted.

State machine 401 transitions from state 9 to state 10 (FIG. 4C, step 424) if the QPSK_Timer expires and the fifo_reset_event signal has not been asserted. In state 10, if the MSE_OK signal is asserted but the fifo_reset_event signal has not been asserted, state machine 401 enters state 11 (step 426). However, if either the fifo_reset_event is asserted or the MSE_OK signal is de-asserted then the state machine enters state 17 (step 422). Step 426 starts a Timer11 and sets the gsm_freeze_aagc signal and the gsm_tx_qpsk signal to zero. The Timer11 is sufficient in duration to allow the modem to adapt to the optimum values for QAM data. If the fifo_reset_event is asserted at any time while in state 11, state machine 401 enters state 17 (step 422.)

If the Timer11 expires and the fifo_reset_event signal has not been asserted, the state machine enters state 12 (step 428), which starts a Timer12 and asserts the gsm_freeze_aagc signal. Timer 12 is sufficiently long to enable the receiver's adaptation loops to settle following the freezing of the analog AGC. If the Timer12 expires and the fifo_reset_event signal has not been asserted, the state machine enters state 13 (step 430). If the fifo_reset_event signal is asserted at any time in state 12 the state machine enters state 17. State 13 is only required in systems that employ scrambling. In other types of systems, state 13 may not be necessary and could be bypassed.

In this example, when state machine 401 enters state 13, a Timer13 is started and a gsm_descram_start signal is asserted, enabling the PCS (Physical Coding Sublayer) state machine. An exemplary PCS state machine is described in reference to FIG. 6 for state machine 600. Referring briefly to FIG. 6, in state 0 (step 602) the following variables are set; all channel delays and a DelayCount signal are set to zero along with a descram_done signal, a LoadDescram signal, a Locked signal, and an AllLocked signal.

The Locked signal may be, for example in a p-channel system, a p-bit signal internal to the PCS state machine, which is used to flag the channels that are locked and unlocked. The Locked signal may be qualified (e.g., bitwise logical OR) with the r_rx_dis signal. The AllLocked signal is, for example, a 1-bit signal that is the logical AND of all of the bits of the Locked signal qualified with the r_rx_dis signal. The LoadDescram signal is, for example, a 1-bit signal that is used to control when the descrambler is initialized, typically with incoming data. The descram_done signal is, for example, a 1-bit signal that is used to declare when all of the channels qualified with the r_rx_dis signal are locked. The DelayCount signal is, for example, an r-bit counter used to monitor the number of delay skew settings that have been attempted.

In state 0 the channel delays are set to zero such that the delay skew is the same on each channel. In subsequent states, the PCS state machine increments each delay until the correct relative delay is found between each channel. The DelayCount signal is used to keep track of the delay skew settings that have been attempted. The Locked signal is initialized to zero, because none of the channels are currently locked. Similarly the 1-bit signal AllLocked is set to zero. Also the descram_done signal is set to zero as this is used to declare when PCS lock has been achieved. The LoadDescram signal is set to zero, which is used to control when the descrambler is initialized.

The system described in reference to FIG. 6 shows an example where a single scrambler produces all the scrambler bits for p-channels, where p≧1. One skilled in the art could easily extend this to use j scramblers where

$$1 \leq j \leq {\sum }_{i = 1}^{p} {b}_{i} ,$$

where bᵢ is the number of bits on the i^{th} channel.

With the gsm_descram_start signal asserted, the state machine enters state 1 (step 604), with a LoadCounter signal, a LockCounter signal, and a LoadDescram signal set to zero. The LoadCounter signal is, for example, a s-bit signal used to ensure that 2^{s}−1 or less incoming bit values are loaded into the descrambler, in order to initialize the descrambler ready for synchronization to the incoming data. In state 2 (step 606), the descrambler is loaded and a LoadCounter incremented for each bit loaded. Since this example implementation has only one descrambler, seed information can be recovered from a single bit. Arbitrarily, this can be chosen to be the least significant bit of a predetermined channel, termed “SigChan”. This least significant bit can have the simplest mapping such that no additional logic is needed. In this example, SigChan is additionally used to transmit the local receiver status.

In this embodiment, if the LoadCounter signal equals 31 and the Descram signal equals zero, the PCS state machine returns to state 1 (step 604). In this example the Descram signal is the state of the descrambler, which in this exemplary case is 21 bits. If the LoadCounter signal equals 31 and the Descram signal does not equal zero, the state machine enters state 3 (step 608), where lock is determined. State 2 ensures that the descrambler is loaded such that all of its bits, for example 21, have been loaded and that the bits are not all zero. As in this example all zero bits would perpetuate zeros and the scrambler will not move from this zero state. This constraint is enforced in the transmitter and is checked for in the receiver.

In state 3 (step 608), with a LoadDescram signal and a Counter signal set to zero, a LockCounter is continually incremented. State 3, for example, compares the output of the descrambler, which was initialized in state 2 step (606), with incoming data for a period measured by the LockCounter, i.e. the LockCounter period (e.g., 1023 clock signals). The LockCounter is, for example a t-bit counter used to ensure a sufficient number of incoming data samples are compared to the descrambler output (for example, 1023 samples).

If during the LockCounter period, the Descram[0] signal, which is the resulting feedback from the descrambler, does not match the incoming data (i.e., Descram[0] does not match SigChan[0]) then the state machine returns to state 1 (step 604). SigChan[0] is the incoming bit stream used to load the descrambler. SigChan[0] represents the least significant bit of the bits decoded from the channel designated to be the signaling channel. In this example the signaling channel is used to initially seed the descrambler and to transmit the local receiver status information. Descram[0] is the resulting closed loop feedback from the descrambler. If the descrambler feedback and the incoming data match for the signal window (for example 1023 samples) then the state machine transitions to state 4 (step 610).

In state 4 (step 610) the descrambler is checked on all channels. If the delay skew has been successfully accounted for, then the descrambled signal should be all zeros (i.e., the bit pattern “X” being all zeros for this example) except for bit[1] of the Signal Channel (SigChan) signal which is dependent on the status of the remote receiver. Consequently, bit[1] is ignored, but all other sequences are checked to verify that zeros are being decoded. If a logical one is decoded in the Counter signal window of, for example, 1023 clocks, then that offending channel is considered unlocked and needs to be flagged as unlocked. This exemplary situation is by no means limited to decoding only zeros. However, it should be noted that the choice of the bit pattern might have an impact on implementation complexity. If the descrambler feedback is not consistent with incoming data (i.e. Descram[0]≠SigChan[0]) then the state machine transitions to state 0 (i.e., indicating that the descrambler is no longer synchronized). If the descrambler feedback and the incoming data do match for the signal window then state machine 600 transitions to state 5 (step 612).

If all of the channels are locked in state 5 (step 612), the state machine enters state 7 (step 616) and the descram_done signal is asserted. The descram_done signal is asserted when the descrambler is locked. If the gsm_descram_start signal is de-asserted, the state machine enters state 8 (step 618), where the descram_done signal is de-asserted. The next time that the gsm_descram_start signal is asserted the state machine reenters state 0 (step 602).

In state 5 (step 612), the DelayCount signal is incremented and the delay on all unlocked channels is incremented, which provides delay skew compensation on a per channel basis, and the signal counter is also reset to zero. Delay skew compensation may be required in systems that employ multiple channels. Typically each channel can experience different delays. It may be critical in order to decode data correctly to compensate for these delay differences.

If the channels are not all locked, and the DelayCount signal is less than some predefined maximum, for example 4, then the state machine re-enters state 4 (step 610), where all the channels are checked as described above. If the channels are not all locked and the DelayCount signal has exceeded or equals the predefined maximum, then the state machine transitions to state 6 (step 614).

In state 6, the DelayCount signal, the AllLocked signal, the Counter and the Locked signal are all set to 0. Also the delay on every channel is set to zero except for the channel designated as the signaling channel, whose delay is incremented. The signal channel (SigChan) is the channel designated to be used to lock the descrambler. This channel is also used to signal the status of the local receiver to the remote receiver. This signaling is achieved by performing a logical Exclusive OR of the local receive status inverse with sequence one on the Signal Channel. In the above example where the bit pattern “Y” is all zeros, then decoding all zeros indicates that the remote communication device is locked.

If the delay on the signal channel (SigChan) exceeds or equals the maximum, the state machine transitions to state 0 (step 602) and the process starts again from initial conditions. If the delay on the signal channel (SigChan) is less than the maximum, the state machine transitions to state 1 (step 604) and the process is repeated with the new delay on the signal channel.

Returning back to FIG. 4C at step 430, if a fifo_reset_event signal is asserted or the Timer13 expires, the state machine will transition to state 17 (step 422) regardless of the state of the PCS state machine (i.e., state machine 600 of FIG. 6). This provides a recovery mechanism if a “bit lock” cannot be achieved in the PCS state machine or if a fifo_reset_event occurs.

If the descram_done signal is asserted, and the Timer13 has not expired, and the FifoResetEvent has not occurred, state machine 401 enters state 14 (step 432) where the gsm_lrs (local receiver status) signal is asserted and a Timer14 is started. Start-up synchronization is achieved in state 14, where the local modem waits for the remote modem to declare their status (noted by the remote receiver status signal or rrs signal). The local modem has already begun to send “good idles” (i.e., the bit pattern “Y”) as these are determined by the gsm_lrs signal.

The remote receiver status circuitry is qualified with the signal descram_done. This means that each modem tries to detect good idles only after it has started transmitting good idles itself. Consequently, closer synchronization is achieved between the two modems than if the remote receiver circuitry was to run freely. The effect is that although one modem will transmit good idles (i.e., the bit pattern “Y”) possibly well in advance of the other, both modems will begin registering the bit pattern “Y” within a few clocks periods of each other (for example 100 or less clock periods).

If Timer14 expires or the MSE_OK signal is de-asserted or the IEC_OK signal is de-asserted or the NormFlag signal is asserted or a FifoResetEvent signal is asserted, the state machine transitions to state 17 (step 422). If none of the above occurs and the remote receiver status (rrs) signal is asserted then state machine 401 transitions to state 15 (step 434).

In state 15 (step 434), a Timer15 is started and the gsm_link_locked signal is asserted to indicate that the local device is ready to receive data. If the MSE_OK signal is deasserted or the NormFlag signal is asserted or the FifoResetEvent signal is asserted whilst in state 15 the state machine will transition to state 17. If none of these have occurred then when the Timer15 expires, state 16 is entered (step 436) and the gsm_tx_data signal is asserted to allow the local receiver to transmit data. This delay is required to ensure that the far end (remote communication device) has entered state 15 before data is transmitted, because the IEC_OK signal would be de-asserted if the far end modem began receiving data (not idle patterns) while in state 14.

The global state machine will then sit in state 16 (step 436) transmitting and receiving data. If the MSE_OK signal is de-asserted or NormFlag is asserted or a FifoResetEvent takes place, state machine 401 will transition to state 17 (step 422). Also, should the signal detect (SD) signal be de-asserted while the global state machine is in any state other than state 0 and state 17 then the state machine will transition to state 17 (step 422).

In some communication systems, the communication devices (e.g., transmit and receive modems) must be frequency locked. For example this may help simplify cross channel cancellation or echo cancellation. To achieve this, typically one communication device must recover its clock from the other communication device. One technique is to decide a priori, which communication device will supply the other with a clock signal, and provide a signal to each end of the communication link to indicate which communication device will operate as a master and which will operate as a slave. The communication device operating as a master will supply the other communication device, which is operating as a slave, with a signal from which it can recover the clock. However, this technique is limited because the two communication devices are not necessarily under the control of one entity that is able to make this master/slave determination.

The two independent modems must be synchronized across the given medium to transmit and receive data reliably so that, for example, each modem knows whether or not to use the recovered clock. In accordance with an embodiment of the present invention, an arbitration technique is disclosed that allows communication devices to determine which is to be a master and which is to be a slave upon start up. For example, in one embodiment, each communication device is capable of generating a random number that is not correlated with the random number generated by the other communication device. This might be achieved for example by sampling the least significant bits of an ADC (analog to digital converter) or by running jittery loops and sampling the least significant bits of an accumulator.

In a multi-channel system this random number could then be used to choose one of the possible subchannels (e.g., one of eight subchannels) on which to transmit. The communication device that selects the lower channel could for example become the slave, while the other communication device becomes the master (or vice versa). This technique could be implemented using the existing signal detect circuitry and controlled via a state machine, as discussed herein. Single channel devices would require a modified technique to arbitrate as to who is master and who is slave.

Specifically, each communication device independently selects a channel on which to transmit and begins transmitting the bit pattern “X” (i.e., bad idles) on that channel. Each communication device also monitors the channels for signal detection on any of its receive channels. If a signal is detected on more than one channel or on the same channel as that communication device is transmitting, then the process is interrupted. The communication device stops transmitting and waits for a fixed period of time so that the other communication device is interrupted also. Another random channel is selected and the bit pattern “X” is transmitted. Once a signal is detected on only one channel and this channel differs from the one that the communication device is transmitting on, the communication device transmitting on the lower channel is determined to be the master and hence the other is the slave.

This determination, made locally by each communication device as to who is the master and who is the slave, could be used directly but it is safer to verify the information, to help ensure that both devices have made the correct decision. In this example the information is verified for a period of time by each communication device transmitting on their originally chosen channel and the channel upon which a signal was detected. Once this is confirmed that each communication device is transmitting and receiving on the same two channels, then the procedure is considered complete.

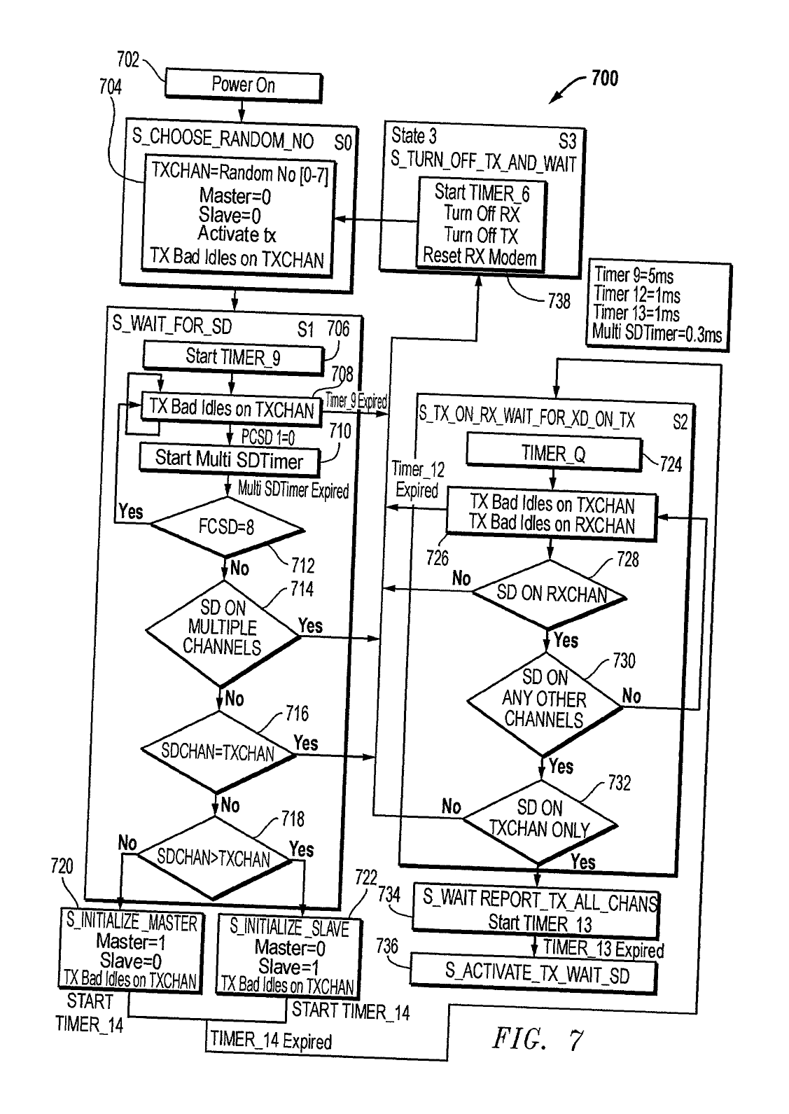

FIG. 7 illustrates a flowchart 700 for a start-up state machine with master-slave arbitration in accordance with an embodiment of the present invention. Flowchart 700 provides an exemplary state machine for implementing a technique, such as described in the above example. After application of power to the communication device (step 702), the state machine enters a state 0 (step 704 and labeled S_CHOOSE_RANDOM_NO). In step 704, the transmitter is activated and begins transmitting the bit pattern “X” on a randomly selected channel. Also the signals Master and Slave are set to zero, since it has not yet been determined whether the device is to be a master or slave.

The state machine transitions to state 1 (steps 706-718 and labeled S_WAIT_FOR_SD) where the channels are monitored for a signal. If the signal is detected on a lower channel, the local communication device becomes the master (step 720). If the signal is detected on a higher channel, the local communication device becomes the slave (step 722). If a signal is detected on multiple channels or on the same channel as the communication device is transmitting on, the state machine enters state 3 (step 738 and labeled S_TURN_OFF_TX_AND_WAIT).

In state 3 the modem is reset and the transmitter switched off for a period defined by the TIMER_{—}6. This forces the far end (remote communication device) to lose signal detect and stop transmitting. When Timer_{—}6 expires, the local state machine transitions to state 0. Exemplary time periods for the timers shown in FIG. 7, such as a Timer6, a Timer9, a Timer12, a Timer13, a Timer14, and a MultiSDTimer are 1, 5, 1, 1, 1, and 0.2 milliseconds, respectively.

After Timer 14 has expired, the state machine transitions to state 2 (steps 724-732 and labeled S_TX_ON_RX_WAIT_FOR_SD_ON_TX) after step 720 or step 722. Timer 14 insures that both devices finish state 1 before transitioning to state 2. In state 2, the communication device transmits on the selected transmit channel and on the detected receive channel to verify with the remote communication device the master/slave arbitration agreement. If a signal is not detected on the receive channel or on more than just the receive and transmit channel, then the state machine enters state 3.

If the conditions in state 2 are satisfactorily met, the state machine proceeds to step 734 (labeled S_WAIT_BEFORE_TX_ALL_CHANS), where the communication device waits until the Timer 13 expires before communicating the desired data (step 736 labeled S_ACTIVATE_TX_WAIT SD). This is to ensure that the link partner has also exited state 2, before the local device starts transmitting on all channels. This ensures that the link partner does not exit state 2 based on triggering signal detect signal on illegal channels which would cause it to restart.

Embodiments described above illustrate but do not limit the invention. It should also be understood that numerous modifications and variations are possible in accordance with the principles of the present invention. For example, the bit pattern “X” and the bit pattern “Y” represent any designated bit pattern predetermined to indicate an unlocked or a locked condition, respectively, of the local receiver. Thus, although a zero and a one bit pattern were given as examples for the respective bit patterns “X” and “Y,” other bit patterns may be employed. It should also be understood that additional information could be passed between the communicating modems using this method. This information could include and is not limited to information regarding channel quality or other arbitrated modes of operation (e.g., choosing different QAM constellations on a per channel basis in order to garner optimum performance for any given channel scenario). Accordingly, the scope of the invention is defined only by the following claims.

We claim:

1. A communication device comprising:
a transmitter;
a receiver; and
a state machine coupled to the transmitter and to the receiver, the state machine controlling the initiation of a communication link for the communication device by determining bit patterns for transmission by the transmitter at the full data rate based upon the status of the receiver and information contained in a signal transmitted by a remote communication device through a communication channel to the receiver.

2. The communication device of claim 1, wherein the state machine commands the transmitter to transmit a first bit pattern if the receiver is not locked to the signal and commands the transmitter to transmit a second bit pattern if the receiver is locked to the signal.

3. The communication device of claim 2, wherein the first bit pattern and the second bit pattern comprise zeros and ones, respectively, that are coded and transmitted by the transmitter.

4. The communication device of claim 2, wherein the communication link is established when the receiver is locked and receiving the second bit pattern.

5. The communication device of claim 1, further comprising a signal detect circuit, coupled to the state machine, which indicates to the state machine when the receiver is receiving a signal of sufficient energy.

6. The communication device of claim 5, wherein the state machine activates the receiver when the signal detect circuit indicates that a signal of sufficient energy is being received.

7. The communication device of claim 1, wherein the state machine comprises circuitry to communicate with the transmitter and the receiver to control operation of the receiver and the transmitter.

8. The communication device of claim 1, wherein the state machine comprises a processor, executing stored instructions, to communicate with the transmitter and the receiver to control their respective operation.

9. The communication device of claim 1, wherein the communication device and the remote communication device determine which will be a master and which will be a slave based upon a master/slave arbitration procedure.

10. The communication device of claim 9, wherein the master/slave arbitration procedure is based on the channel selected by the communication device and the remote communication device.

11. A method of establishing a communication link between a local communication device and a remote communication device, the method comprising:
transmitting at a full data rate a first bit pattern from the local communication device to the remote communication device if a receiver of the local communication device is not locked to an incoming signal;
transmitting at a full data rate a second bit pattern from the local communication device to the remote communication device if the receiver of the local communication device is locked to an incoming signal; and
establishing the communication link for transmission of desired information when the receiver of the local communication device is locked and is receiving the second bit pattern from the remote communication device.

12. The method of claim 11, further comprising activating the receiver of the local communication device upon detection of a signal from the remote communication device.

13. The method of claim 12, further comprising resetting the receiver and the transmitter if the communication link fails and after a period of not transmitting then retransmitting at a full data rate a first bit pattern from the local communication device to the remote communication device.

14. The method of claim 11, further comprising performing a master/slave arbitration procedure to determine for the local communication device and the remote communication which will be a master and which will be a slave.

15. The method of claim 14, wherein the master/slave arbitration procedure is based on a transmit channel selected by the local communication device and the remote communication device.

16. A communication device comprising:
a receiver adapted to receive an input signal;
a transmitter to transmit an output signal;
a detection circuit adapted to detect the receipt of the input signal; and
a state machine, coupled to the receiver, the transmitter, and the detection circuit, adapted to control start-up of the communication device to establish a communication link with a remote communication device, wherein the state machine determines bit patterns to transmit at a full data rate based upon the status of the detection circuit, the receiver, and the input signal.

17. The communication device of claim 16, wherein the state machine commands the transmitter to transmit a first bit pattern or a second bit pattern depending upon whether the receiver is unlocked or locked, respectively.

18. The communication device of claim 17, wherein the communication link is established when the receiver is receiving the second bit pattern and the transmitter is transmitting the second bit pattern.

19. The communication device of claim 16, wherein the state machine determines whether the communication device is a master or a slave based on a transmission channel selected by the communication device and the remote communication device.
